(19) United States
(12) Patent Application Publication
(10) Pub. No.: US 2008/0294511 A1
(43) Pub. Date: Nov. 27, 2008

(54) INCENTIVIZING CONSUMER PURCHASES

(76) Inventor: Frank Robert Gussoni, Trooper, PA (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 11/751,700

(22) Filed: May 22, 2007

(51) Int. Cl. G06Q 30/00

(52) U.S. Cl. 705/14

(57) ABSTRACT

A system and method for directing a consumer to a first location is disclosed. The system may include a datastore and a processor. The datastore may store first data indicative of a product, a first location, and an incentive. The incentive may be redeemable at the first location. The processor may be in communication with the datastore. The processor may receive an online request for the product from the consumer. The consumer may be presented with a description of the product and a video associated with the product. The processor may present to the consumer second data indicative of the incentive and the first location. The second data may reference the online request. The second data may be presented in a printable form.

### BACKGROUND

Traditional retailers face decreasing foot traffic and sales in light of growing online commerce. When transactions are made in-person rather than online, businesses with both virtual and physical store-fronts realize distinct benefits, such as additional purchases, impulse purchases, and the opportunity to establish goodwill. Less in-store sales means less opportunity to realize some of these benefits.

In the past, some online commerce systems have partnered with physical, “bricks and mortar” stores, but such systems have been limited. Once a consumer has completed payment online, the consumer may pick-up the item at the physical store, rather than having it shipped to the consumer's home. While such systems may provide a convenience to the consumer, they do not provide the benefits mentioned above. For example, when picking-up a purchase, the consumer may not be presented with the option of adding additional items.

In addition, suppliers that rely on bricks and mortar retailers often have limited influence on the ultimate buying decision of the consumer. Generally, the retailer controls a customer's buying experience with final price determination, product display placement (such as eye-level shelves and endcaps—the portion of shelving exposed to wide isles), promotions, and the like. As a result, suppliers may have limited channels for communicating with the consumer in a way that has a direct impact on the ultimate buying experience. For example, suppliers have used coupons and mail-in rebates to establish some influence over the buying decision without the retailer's involvement, but these methods are inefficient. For example, they do not consider the specific needs of an individual consumer.

Thus, there is a need to leverage online channels to incentivize in-store purchases.

### SUMMARY

A method for directing a consumer to a first location is disclosed. First data indicative of a product, a first location, and an incentive may be received. The incentive may be redeemable at the first location. An online request for the product may be received from the consumer. The online request may include selecting the product by supplier, selecting the product by product type, and entering search terms related to the product, for example.

The consumer may be presented with a description of the product and a video associated with the product. The consumer may be presented with second data indicative of the incentive and the first location. The second data may be linked to the receiving of the online request. The incentive may include a percentage discount and/or a reduction in price of the product, for example. The incentive may be determined based on a rule set that considers the online request history of the consumer. The second data may be presented in a printable form.

A system for directing a consumer to a first location is also disclosed. The system may include a datastore and a processor. The datastore may store first data indicative of a product, a first location, and an incentive. The incentive may be redeemable at the first location. The processor may be in communication with the datastore. The processor may receive an online request for the product from the consumer. The processor may present to the consumer second data indicative of the incentive and the first location. The second data may reference the online request.

### BRIEF DESCRIPTION OF THE DRAWINGS

FIG. 1A depicts an exemplary system for directing a consumer to a location;

FIG. 1b depicts an exemplary data server;

FIG. 1c depicts an exemplary offer record;

FIG. 2 is a process flow diagram illustrating an exemplary method for directing a consumer to a location; and

FIGS. 3a-3d depict exemplary web pages for interacting with a consumer.

### DETAILED DESCRIPTION

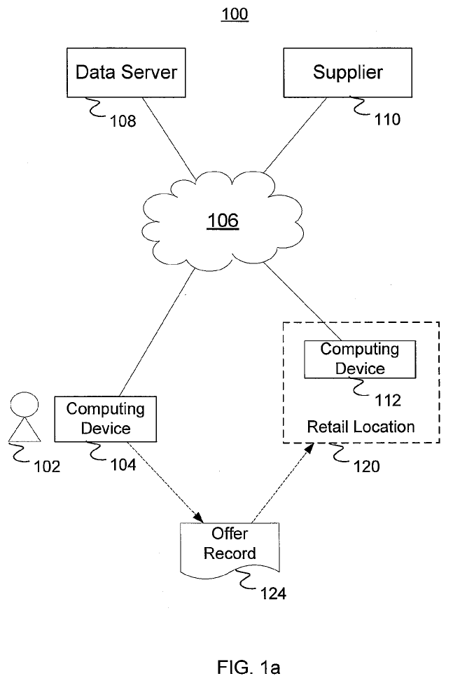

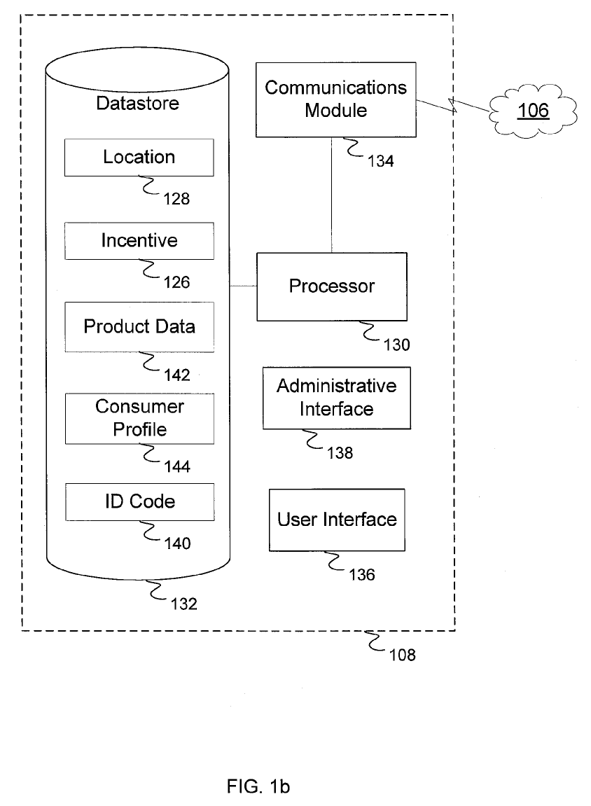

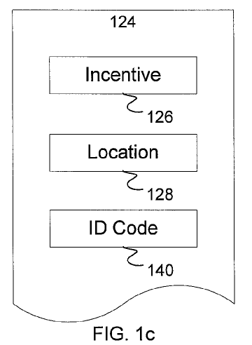

FIG. 1a depicts an exemplary system 100 for directing a consumer to a location. The system 100 may include a network 106 that connects a data server 108, a consumer's computing device 104, a retail location's computing device 112, and/or a supplier 110. The network 106 may be any system suitable for communicating data. For example, the network may be the Internet. In one embodiment, the network 106 may be an intranet, extranet, local area network (LAN), wide area network (WAN), a public switched telephone network (PTSN), Global System for Mobile Communication (GSM), wireless LAN, Institute of Electrical and Electronics Engineers (IEEE) 802.11x, and the like.

The consumer's computing device 104 may be a personal computer (PC), laptop computer, handheld device such as a personal digital assistant (PDA), cellular phone, and the like. The computing device 104 may be any device suitable for connecting to the network 106 and/or engaging the consumer 102 and/or the data server 108.

In one embodiment, the consumer 102 may engage the data server 108 via a telephone. The consumer 102 may set up a voice connection with an interactive voice response (IVR) unit in operative communication with the data server 108. The consumer 102 and/or data server 108 may communicate using text-to-speech, recorded voice prompts, speech recognition, dual-tone multi-frequency (DTMF) detection, and/or similar technologies.

In one embodiment, the consumer 102 may use the computing device 104 to communicate with the data server 108. For example, the consumer's computing device 104 may be loaded with software suitable for communicating with the data server 108. For example, the software may be an Internet browser, Really Simple Syndication (RSS) feed reader, usenet newsreader, e-mail client, and/or other software that provides interaction between the consumer 102 and the data server 108. The consumer 102 may request and/or view a website presented by the data server 108. The data server may include a web server for communicating with the consumer's computer 104 via hypertext transfer protocol (HTTP).

The consumer 102 may engage the data server 108 to research a product. Referring to FIG. 1b that depicts an exemplary data server the data server 108 may include a processor 130 in operative communication with a datastore 132 and/or a communications module 134. The data server 108 may enable a consumer interface 136 and/or an administrative interface 138. The datastore 132 may store data indicative of a product 142, a location 128, and/or an incentive 126.

The product may be in the form of a good, a service, and/or a combination of the two. The product may be a tangible and/or intangible item. For example, the product may be an entitlement and/or other rights that may be purchased and/or sold.

In one embodiment, the location may represent any physical modality in which the product may be purchased. For example, the location 128 may include a retail store at which the product may be purchased. Also for example, the location 128 may include the name of a business that includes a number of retail stores, such as the name of a national retailer and/or franchise.

In one embodiment, the incentive 126 may be any benefit that may tend to motivate the consumer 102 to purchase the product. For example, the incentive 126 may include a percentage reduction in the purchase price of the product. Also for example, the incentive 126 may include a fixed reduction in the purchase price of the product. In another embodiment, the incentive 126 may include a free gift and/or other compensation for purchasing the product. For example, the incentive 126 may grant the consumer a reduction in the overall price when a collection of items are purchased such that the product is included in the collection of items. In another embodiment, the incentive 126 may take the form of an exclusive offer and/or exclusive product. In an embodiment, the incentive 126 may include special financing. For example, the incentive 126 may provide a loan with a lower interest rate and/or enhanced loan terms.

The communications module 134 may enable communication between the processor 130 and the network 106. The administrative interface 138 may provide an interface for provisioning, support, maintenance and the like. For example, data indicative of the product 142, location 128, and incentive 126 may be received from a supplier 110 and/or retailer 120 through the administrative interface. The administrative interface may support HTTP, extensible markup language XML, and the like. The consumer interface 136 may be a website and/or other interface that may be presented to the consumer 102. When the consumer 102 engages the data server 108, the processor 130 may pull data from the datastore 132 to format according to the consumer interface 136 and present as a webpage to the consumer 102.

Upon engaging the data server 108, the consumer 102 may be presented with a welcome message. For example, the welcome message may include text, graphics, animation, and the like. The consumer 102 may be presented with the ability to browse categories and/or subcategories of products. For example, the consumer 102 may be able to browse by product type, supplier, and/or other such product descriptors. Also for example, the consumer 102 may search for a product. The data server 108 may respond to search terms entered by the consumer 102, and the data server 108 may display of a list of products related to the search terms.

Information related to the products displayed by the data server 108 may be stored in the datastore 132. This data may have been provided by the supplier 110, retailer 120, and/or third-party, for example. The product information may include the product's model number, the supplier's name, the supplier's logo, a description of the product, an image of a product, the stock keeping unit (SKU) associated with the product, an audio/video presentation associated with the product, and the like. For example, the information may include an embedded product video and/or audio that includes testimonials, demonstrations of the product, advertising messages related to the product, commercials, consumer-created content, and the like. Each product may include more than one product video, and each product video may be selected and/or played by the consumer 102.

Within a session with the data server 108, the consumer 102 may browse multiple products. While the consumer 102 navigates the website, viewing product information and/or product videos, the data server 108 may track the consumer's progress. For example, the server may maintain a log that records the consumer's interaction with the data server 108. In one embodiment, the log may record the consumer's click-path and/or the duration for which each web page is displayed.

Each consumer 102 may be associated with a consumer profile 144. The consumer profile 144 may include the consumer's name, address, e-mail address, and/or other such biographical information. The consumer profile 144 may also include consumer preferences as directly and/or indirectly indicated by the consumer 102. For example, the consumer's click path and/or page durations may indirectly indicate the consumer's preferences in products.

Also within the session with the data server 108, the consumer 102 may engage a offer record 124 associated with a product. Referring to FIG. 1c that depicts an exemplary offer record, each product may be associated with one or more offer records. The offer record 124 may include the incentive 126 related to the product. The incentive 126 may be retrieved from the datastore 132. Where the incentive is static, it may be displayed directly to the consumer 102. Where the incentive 126 is dynamic, it may be calculated based the associated rule set. In one embodiment, the rule set may consider the consumer's profile 144 in determining the incentive 126. The dynamic incentive 126 may be based on the consumer's history, click-path and/or browsing patterns, the consumer's location, and/or any other information available to the system. For example, where a consumer's history indicates that the consumer 102 browses across many different products, the incentive 126 for a given product may be greater than that if the consumer 102 viewed only one product.

The offer record 124 may include the location 128 associated with the product. In one embodiment, the location 128 may be retrieved from the datastore 132. The offer record 124 may include a map depicting one or more physical places that correspond to the location 128 associated with the product. The location 128 may be retrieved from the datastore 132. The location 128 may be selected within a specified vicinity to the consumer 102. The offer record 124 may also contain the product name, the supplier's name, the product's SKU, the terms and/or conditions related to the incentive, the consumer's name, and/or an identification code 140. The identification code 140 may be stored in the data store 132.

The identification code 140 may reference the online request that was received from the consumer 102 when requesting information about the product. For example, the identification code 140 may indicate the consumer 102 and/or specific session during which the offer record 124 was displayed to the consumer 102. For example, the identification code 140 may be linked and/or keyed to the consumer's interaction with the data server 108. Also for example, the identification code 140 may be linked to the consumer profile 144.

The offer record 140 may be in any format that may be presented to at a retail location 120 for redemption. For example, a offer record 140 may be displayed as a webpage that the consumer 102 may print using a printer connected to the consumer's computing device 104. In one embodiment, the offer record 140 may include a bar code for encoding data. The bar code may be formatted as a universal product code (UPC). The bar code may include a coupon code within the UPC format.

In one embodiment, the offer record 140 may be displayed on a handheld device such as a PDA and/or cell phone. For example, the offer record 140 may be sent to the consumer's handheld device. The bar code may be displayed on the screen of the handheld device such that it may be redeemed at a retail location 120 when purchasing the product. The retail location 120 may include a computing device 112 for scanning and/or recording the offer record 140 for redemption.

In one embodiment, the offer record 140 may be virtual. For example, the offer record 140 may include data sent to the retail location 120, such that when the consumer 102 presents identification at the time of purchase, the consumer 102 may be correlated with the offer record 140. In another embodiment, the offer record 140 may be associated with the consumer's credit card. For example, the offer record 140 may be automatically redeemed when the consumer 102 purchases the product with the credit card.

In one embodiment, the offer record 140 may be mailed and/or shipped to the consumer 102. In another embodiment, the consumer 102 may have a plastic card and/or other identifier associated with the incentive system 100. For example, the identifier may be linked to the consumer's profile 144 and/or further linked to the offer record 140, such that when the plastic card and/or other identifier is presented at the retail location 120 with purchase of the product, the incentive 126 may be credited to the consumer 102.

The consumer 102 may purchase the product at the retail location 120 designated by the location 128 of the offer record 124. The retail location 120 may be any location that presents the opportunity to purchase the product and/or that credits the incentive 126. For example, the retail location may be a store, outlet center, mall, and the like. At the retail location 120, the consumer 102 may present the offer record 124 to redeem the incentive 126. The retail location 120 may include a computing device 112 suitable for processing the offer record 124 and/or crediting the consumer 102 the incentive 126. For example, the computing device 112 may include a barcode scanner in operative communication with a processor. The barcode scanner may decode the bar code associated with the offer record 124.

In one embodiment, the computing device 112 may communicate the purchase of the product and/or the redemption of the incentive 126 to the supplier 110 directly via the network 106. In another embodiment, the computing device 112 may communicate the purchase of the product and/or the redemption of the incentive 126 to the supplier 110 indirectly via network 106 and/or the data server 108. This reporting may include the identification code 140 of the offer record 124. The supplier 110 may receive from the data server 108 data indicative of the products, description views, video views, and/or offer records issued that are associated with the supplier 110.

This data may be correlated with data tracked by the data server 108. For example, the supplier 110 and/or the retailer 120 may receive a report that includes the number of times a product video has been viewed and/or the number of offer records 124 that have been issued. Based on the identification code 140, the specific session of the consumer 102 that generated the offer record 124 may be correlated to the purchase of the product. As aggregated across many consumers, this data may provide an indication of the effectiveness of the product description, product video, and/or incentive 126, for example. Additional data may include the location purchase, the time and/or date of the purchase, an aggregate cost of the order, and/or a list items purchased. The data may include comparison information relating to the supplier's products, videos, and/or offer records 124 as compared to that of other suppliers, for example.

Incentives 126 provided by retailers may be modulated to motivate consumers to consummate their online purchases at the retail location 120. Incentives 126 provided by suppliers 110 may be modulated to motivate consumers to purchase their product instead of a competitor's product. In one embodiment, the level of the incentive 126 may be modulated based on stock and/or inventory levels. Because the location 128 at which the incentive 126 may be redeemed may be included in the offer record 124, a supplier 110 and/or retailer 120 may modulate the incentive 126 and/or location 128 to drive consumers 102 to areas of high inventory, rather than and/or in addition to, moving inventory to areas of higher demand.

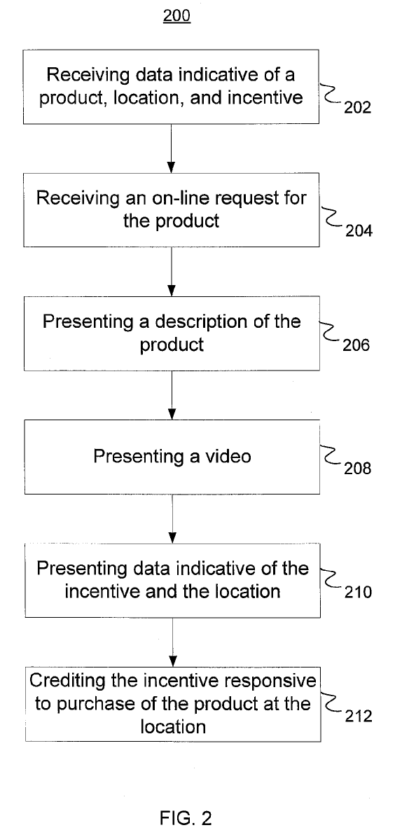

FIG. 2 is a process flow diagram illustrating an exemplary method 200 for directing a consumer 102 to a location 128. At 202, data indicative of a product 142, location 128, and/or incentive 126 may be received. In one embodiment, this information may be sent directly to the data server 108 electronically and/or it may be communicated to an administrator who enters the data into the data server 108 via the administrative interface 138. The data indicative of a product 142 may include product name, product SKU, and/or the name of supplier, for example. The data indicative of a product 142 also may include product information, a description of the product, an image and/or picture of the product, and/or one or more videos depicting the product and/or describing it, for example. The incentive 126 may be provided by the supplier of the product, and/or it may be provided by the retailer of the product.

The data indicative of the location 128 may include the name and/or physical placement of a retail location 120 and/or outlet at which the product may be purchased. For example, the location 128 may include a street address of the retail location 120. The location 128 may include the name of the store and/or business at which the product may be purchased and/or at which the incentive 126 may be credited.

At 204, the data server 108 may receive an online request for a product from the consumer 102. The online request may be received in the form of an HTTP request at a website. In one embodiment, the online request may include a selection by the consumer of a product that is sorted by supplier. In one embodiment the online request may take the form of the consumer selecting a product sorted by the type of product. In another embodiment, the online request may include a search term entered by the consumer 102. The search term may include the product's name, the supplier's name, terms related to the nature and/or function of the product, and the like.

At 206, data indicative of the product may be presented, responsive to the online request. For example, data indicative the product may include the product name, a picture of the product, the supplier's name, the product SKU, a description of the product, and the like. At 208, the consumer 102 may continue to browse product information such as a video depicting and/or describing the product. The data indicative of the product may be presented to the consumer all at once and/or in stages. For example the consumer 102 may be first presented with the name and/or image of the product, and upon receiving another online request for the product, the consumer 102 may be presented with a description. The description may include a number of hyperlinks to product videos.

At 210, the consumer may be presented with data indicative of the incentive 126 and/or the location 128. This data may reference the online request. In one embodiment, the incentive 126 and/or the location 128 may be displayed on a computer screen, the display of a handheld device and/or cell phone, and the like. The incentive 126 and/or location 128 may be presented to the consumer 102 via a webpage, such that the consumer 102 may print out the incentive 126 and/or location 128 information. The data presented to the consumer 102 may include the supplier's name, the product name, the product SKU, the terms and conditions of use associated with the incentive 126, details associated with the incentive 126, the consumer's name, and/or an identification code 140 that relates to this instance of presenting the data. Such an identification code 140 may be a serial number linked to the transaction. The data indicative of the incentive 126 and/or location 128 may be stored in an offer record 124. The incentive 126 may be provided by the supplier of the product, and/or it may be provided by the retailer of the product. More than one incentive 126 may be provided. For example, a first incentive 126 may be provided by a supplier of the product, and a second incentive 126 may be provided by a retailer of the product.

At 212, a retailer may credit the incentive 126 with purchase of the product at the location 128. The consumer 102 may present data indicative of the incentive 126 and/or location 128 to the retailer, and the consumer 102 may redeem the incentive 126 at the location 128. For example, the consumer 102 may physically travel to the location 128 and purchase the product. At the point-of-sale, the consumer 102 may present the incentive 126 to the retailer. The incentive 126 may be encoded as a barcode coupon, for example. The retailer may credit the incentive 126 upon purchase the product and/or at a later time. The retailer may consider the terms and conditions of use associated with the incentive 126 when crediting the incentive 126.

All and/or part of the process described in FIG. 2 may be encoded in computer executable instructions via a computer programming language. The computer executable instructions may be stored on a computer readable medium, for example a hard drive, CD-ROM, DVD-ROM, and the like.

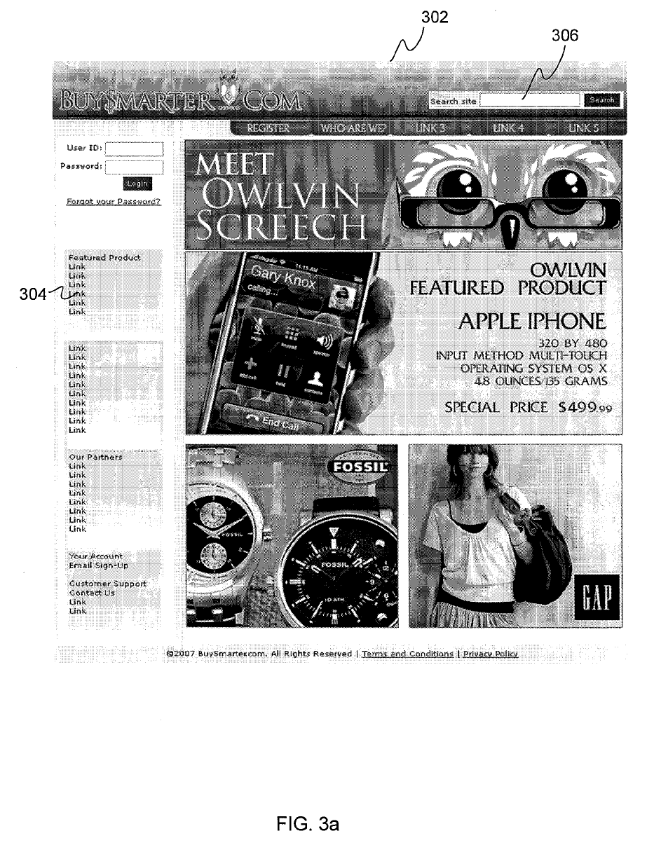

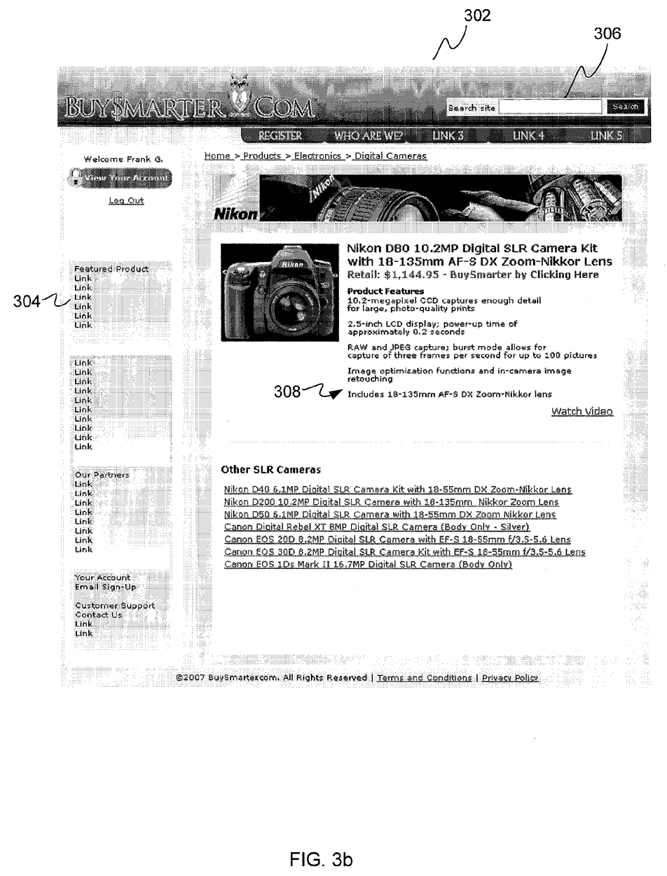

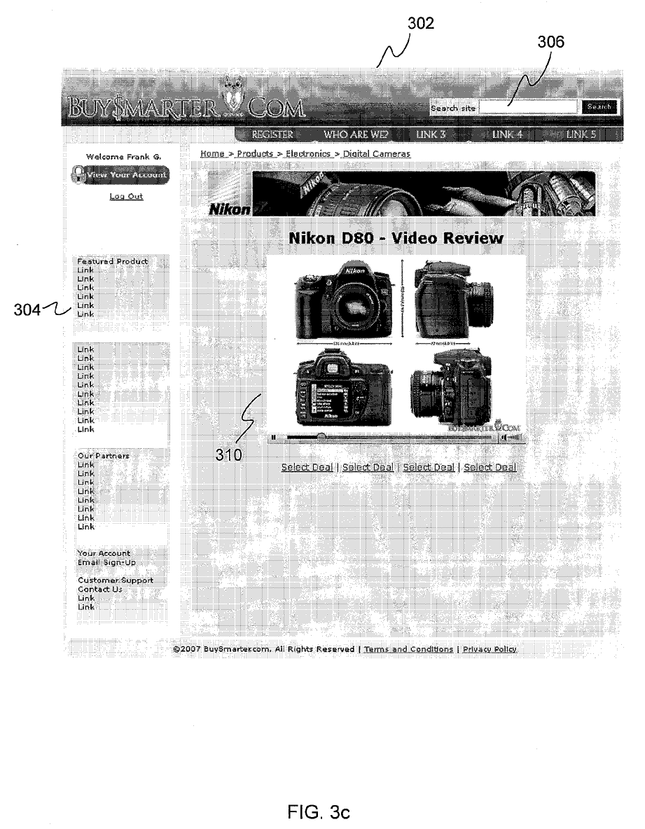

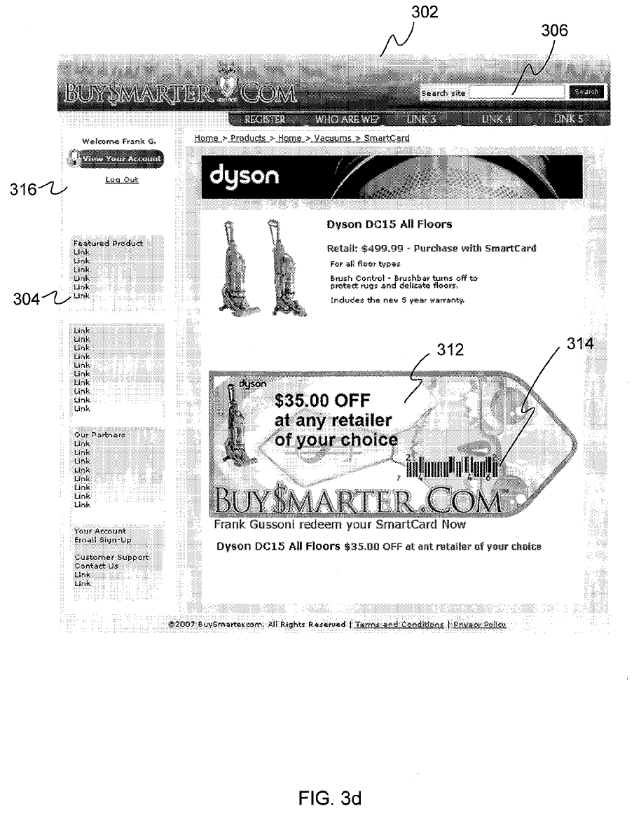

FIGS. 3a-3d depict an exemplary website 302 for interacting with a consumer 102. The website 302 may receive an online request from the consumer 102. For example, the website 302 may include links 304. Each link 304 may be associated with a product. The links 304 may be organized by supplier, product type, and the like. Also for example, the website 302 may include a search box 308 that may receive search terms from the consumer 102. Responsive to the consumer's search terms, the website 302 may display products associated with the search terms.

Once the consumer 102 has selected a product, the website 302 may display a description 308 of the product. For example, the website 302 may display an image of the product, technical and/or descriptive information about the product, the product's typical cost, and the like. In addition, the website may present a video 310 to the customer 102. The video 310 may be associated with the selected product.

The website 302 may present the consumer 102 with data 312 indicative of an incentive. For example, the data 312 may be presented as part of a printable webpage. The data 312 may relate to the consumer's online request by an identification code 314. For example, the identification code 314 may be encoded as a bar code. The website may store a profile 316. The profile 316 may be associated with a consumer. The data 312 may be linked to the profile 316. The consumer 102 may purchase the product at a location and/or redeem the incentive.

As a useful and tangible result, the consumer 102 may make other purchases at the location that may have not otherwise been made had the consumer 102 purchased a product online. In addition, the retail location 120 may engender goodwill with the consumer 102 on the basis of the face-to-face interaction. Where the supplier 110 provides the incentive 126, the consumer 102 may purchase the supplier's product over a competing product on the basis of the incentive 126. In addition, the consumer 102 may be less likely to purchase a competing product at the retail location 120 because the consumer 102 has already been presented the incentive 126 prior to and/or concurrently with arriving at the retailer location. Furthermore, retailers and/or suppliers may modulate the incentive 126 and/or location 128 to increase efficient distribution of inventory and/or stock.

What is claimed:

1. A method for directing a consumer to a first location, the method comprising:
receiving first data indicative of a product, a first location, and an incentive, wherein the incentive is redeemable at the first location;
receiving an online request for the product from the consumer;
presenting to the consumer second data indicative of the incentive and the first location, wherein the second data relates to the receiving the online request.

2. The method of claim 1, wherein the first location comprises a physical store.

3. The method of claim 1, wherein the incentive comprises a percentage discount.

4. The method of claim 1, wherein the incentive comprises a reduction in price.

5. The method of claim 1, wherein the incentive comprises special financing.

6. The method of claim 1, wherein the incentive is provided by a supplier of the product, and wherein the second data is indicative of a second incentive that is provided by a retailer of the product.

7. The method of claim 1, wherein the first location comprises a plurality of physical stores.

8. The method of claim 1, further comprising presenting at least one of a video or an audio associated with the product to the consumer.

9. The method of claim 1, wherein the receiving an online request comprises selecting a product by supplier.

10. The method of claim 1, wherein the receiving an online request comprises selecting a product by product type.

11. The method of claim 1, wherein the receiving an online request comprises receiving search terms from the consumer.

12. The method of claim 1, wherein the presenting comprises presenting in a printable form.

13. The method of claim 1, further comprising storing a profile associated with the consumer.

14. The method of claim 13, wherein the second data is linked to the profile.

15. The method of claim 1, wherein the incentive is determined based on a rule set.

16. The method of claim 15, wherein the rule set relates to the online request history of the consumer.

17. The method of claim 1, further comprising receiving indication of redemption of the incentive.

18. The method of claim 1, wherein the second data relates to the receiving the online request by an identification code.

19. The method of claim 18, further comprising reporting the identification code.

20. A system for directing a consumer to a first location, the system comprising:
a datastore that stores first data indicative of a product, a first location, and an incentive, wherein the incentive is redeemable at the first location; and
a processor in communication with the datastore, wherein the processor receives an online request for the product from the consumer and presents to the consumer second data indicative of the incentive and the first location, wherein the second data relates to the online request.

21. The system of claim 20, wherein the first location comprises a physical store.

22. The system of claim 20, wherein the incentive is determined based on a rule set.

23. The system of claim 20, wherein the rule set considers the online request history of the consumer.

24. The system of claim 20, wherein the incentive comprises a percentage discount.

25. The system of claim 20, wherein the incentive comprises a reduction in price.

26. The method of claim 20, wherein the incentive comprises special financing.

27. The system of claim 20, wherein the processor presents a description of the product to the consumer.

28. The system of claim 20, wherein the processor presents at least one of a video or an audio associated with the product to the consumer.

29. The system of claim 20, wherein the online request comprises a selection of the product, wherein the product is organized by supplier.

30. The system of claim 20, wherein the online request comprises a selection of the product, wherein the product is organized by product type.

31. The system of claim 20, wherein the online request comprises receiving search terms from the consumer.

32. The system of claim 20, wherein the processor presents the second data in a printable form.

33. The system of claim 20, wherein the datastore stores a profile associated with the consumer.

34. The system of claim 33, wherein the second data relates to the profile.

35. The system of claim 20, wherein the processor receives indication of redemption of the incentive.

36. The system of claim 20, wherein the second data relates to the receiving the online request by an identification code.

37. The system of claim 36, wherein the processor reports the identification code.

38. A computer-readable medium for directing a consumer to a first location having computer instructions stored thereon that when executed perform a method comprising:
receiving first data indicative of a product, a first location, and an incentive, wherein the incentive is redeemable at the first location;
receiving an online request for the product from the consumer;
presenting to the consumer second data indicative of the incentive and the first location, wherein the second data relates to the receiving the online request.
